(19) United States
(12) Patent Application Publication
(10) Pub. No.: US 2026/0040254 A1
(43) Pub. Date: Feb. 5, 2026

(54) SMART REGISTRATION AND DISCOVERY OF NETWORK FUNCTIONS

(71) Applicant: HEWLETT PACKARD ENTERPRISE DEVELOPMENT LP, Spring, TX (US)

(72) Inventors: Ravi Saxena, Bangalore (IN); Mousumi Bhattacharya, Bangalore (IN); Sanjeeva Manvi, Bangalore (IN)

(21) Appl. No.: 18/899,309

(22) Filed: Sep. 27, 2024

(30) Foreign Application Priority Data
Jul. 31, 2024 (IN) 202411058212

(51) Int. Cl. H04W 60/00; H04W 28/084; H04W 48/16

(52) U.S. Cl. CPC H04W 60/00; H04W 28/084; H04W 48/16

(57) ABSTRACT

Systems and methods are provided for the implementation of a locality-priority parameter that can specify a plurality of locality-priority preferences regarding locality-based satisfaction of a service request set forth by a network function (NF) consumer. NF producers may register profiles with a Network Repository Function (NRF). An NF consumer may perform discovery to identity NF producers that are capable of satisfying the service request, the NRF sending registered profiles of capable NF producers based on the locality-priority parameter.

### BACKGROUND

Wireless or mobile devices (e.g., smart phones, tablets, and laptops) are used to send and receive data. Such data may be transmitted and received over a wireless/mobile network. 5G is a standard promulgated by the International Telecommunication Union (ITU) and the 3rd Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, e.g., exponentially faster data download and upload speeds, along with much-reduced latency (also referred to as “air latency,” i.e., the time it takes for a device to communicate with the network). Another advantage of 5G is the introduction of network slicing, which can refer to the ability to create/operate multiple virtual networks, each designed/dedicated to a specific use case, for example.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of network function (NF) in a 5G core network that can leverage examples of the disclosed technology.

FIG. 2 illustrates an example of NF interactions between an NF service consumer and producer in accordance with examples of the disclosed technology.

FIG. 3 illustrates an example of a network routing scenario in accordance with examples of the disclosed technology.

FIG. 4 illustrates an example of a network routing interaction using improved profile registration in accordance with examples of the disclosed technology.

FIG. 5 is an example computing component that may execute instructions to effectuate smart registration and NF discovery in accordance with one example of the disclosed technology.

FIG. 6 is an example computing component that may execute instructions to effectuate smart registration and NF discovery in accordance with one example of the disclosed technology.

FIG. 7 is an example computing component that may be used to implement various features of examples of the disclosed technology.

The figures are not exhaustive and do not limit the present disclosure to the precise form disclosed.

### DETAILED DESCRIPTION

A mobile network typically comprises two component networks, the radio access network (RAN) and the core network. For wireless networks operating in accordance with the 5G standard, these component networks are the 5G access network (5G-AN) and the 5G core network (5GC). The 5GC network (or domain) handles various functions like connectivity, mobility management, etc., and is based on a Service-Based Architecture (SBA). Network functions (NFs) are the services/micro-services that realize such 5GC functionality.

Examples of virtualized NFs, include, for example, an Access and Mobility Management Function (AMF), a Session Management Function (SMF), and an Authentication Server Function (AUSF). Another NF of the 5GC is referred to as a Network Repository Function (NRF), a central registry that can hold information about the NFs of the 5GC, which can then be shared with any NF, when required. That is, the NRF is itself, a 5GC NF that acts as a services discovery broker for NFs in the 5GC. Service discovery is a process for finding instances of a service(s)/resource(s)/NF(s) that can fulfill a particular service request.

In order to be discoverable, NFs and their microservices register themselves with or into the NRF. Using service discovery, as discussed above, NFs can discover registered NFs/microservices to fulfill service requests. Thus, if an NF service “consumer” (also referred to as an NF consumer or consumer) wishes to satisfy some service, the NF consumer can send a discovery message to the NRF, which returns an appropriate NF instance profile of an NF service “producer” (also referred to as NF producer or producer) that can satisfy the service request. The NF consumer may then transmit the service request to the NF producer identified by the NF instance profile returned to the NF consumer by the NRF. The NF producer may provide a service response back to the NF consumer, e.g., it may return certain data or a particular resource URL that can be used to satisfy the service request. If the NF consumer has a subsequent request, it may transmit that subsequent request to the identified NF producer, and the process continues.

In conventional implementations, NFs register themselves at the NRF by uploading an NF profile, which contains information about the NF producer, the services it provides, the locality that it serves, and so on. Typically, in a given deployment, NFs are grouped together based on locality, and discover an appropriate NF producer indicating the locality it serves and some assigned, relative priority. However, 3GPP constrains each NF profile to a single locality, even though an NF producer may be able to serve multiple localities. The result is that instances of a single NF producer may be registered with multiple profiles in the NRF, each profile being tied to a particular locality and priority. This makes storing and maintaining NF producer profiles in the NRF complex. This complexity only increases when the number of NF consumers, NF producers, and/or localities increases.

For example, in order for a co-located NF producer to service an NF consumer, the NF producer must register itself with the NRF using a first profile that, e.g., specifies the same locality as that of the NF consumer and a first/primary priority. However, NF producers may go down/become inaccessible for various reasons, and for redundancy, the NF producer may be registered at the NRF with another profile specifying another locality and another priority such that if one NF producer that was supposed to service a particular NF consumer goes down, another NF producer can be discovered to satisfy a service request.

Accordingly, examples of the disclosed technology address the above limitations by introducing an optional parameter, localityPriority, that can be added to an NF producer profile. This localityPriority can be an array data type (locality, priority), and can be used to capture/present information regarding multiple localities/priorities in a single profile when there is a requirement or specification that multiple localities be supported by an NF producer. In this way, multiple localities and priorities can be defined without a need for an NF producer to register multiple profiles with the NRF. This also negates the aforementioned single locality-per-profile constraint in the 3GPP standard. When an NF consumer sends a discovery request specifying a locality to the NRF, the NRF can return the profiles of any NF producers whose specified localities match that of the discovery request. Depending on the corresponding priorities, the NF consumer can select, e.g., one of the NF producers associated with a returned profile to which a service request can be sent. It should be noted that the priority aspect of the localityPriority addresses an order of use, where an NF consumer may wish to have a service request satisfied by an NF producer in the same locale, but if that NF producer goes down, the NF consumer's service request can be satisfied by a next NF producer in accordance with a next priority value, and so on.

It should be noted that examples of the disclosed technology are described in the context of NF locality and priority. However, the disclosed technology is not necessarily limited to this application. If there are other factors/parameters that, in conventional implementations, require an NF producer to register itself under multiple profiles, examples of the disclosed technology may be also used to overcome the limitations of those factors/parameters.

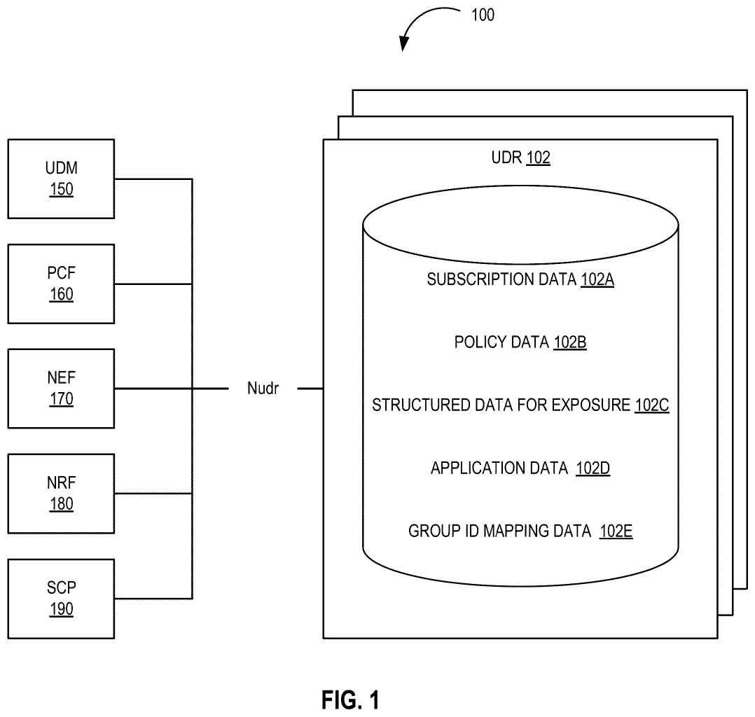

FIG. 1 illustrates an example data storage architecture 100 within which examples of the disclosed technology may be implemented. As illustrated in FIG. 1, data storage architecture 100 may include one or more User Data Repositories (UDRs) 102. As alluded to above, UDRs can refer to repositories for storing data grouped into different sets of information that may be accessed by various network services. These network services, referred to as NFs, may have defined functionalities such as authentication, policy control, and session management. The different types of information stored within the UDR may correspond to such functionalities and may include subscription data, authentication data, application data, and policy data. In the example data storage architecture 100, UDR(s) 102 may store subscription data 102A, policy data 102B, structured data for exposure 102C, application data 102D, and Group ID mapping data 102E. It should be noted that the types of stored data in UDR 102 (s) are examples, and not intended to be limiting in any way. UDR(s) 102 may store, as well as receive, subscription data 102A, policy data 102B, structured data for exposure 102C, application data 102D, and Group ID mapping data 102E. Moreover, UDR(s) 102 may support subscriptions (of NFs, for example,) to notifications, where UDR(s) 102 may notify an NF subscriber of changes to data to which it is subscribed.

A Nudr interface may be leveraged by NFs to communicate with UDR(s) 102, e.g., access a particular set of data stored in UDR(s) 102. Some NFs that may send service requests to access data stored in UDR(s) 102, may include, but are not limited to Unified Data Management (UDM) 150 (described in greater detail below), the Policy Control Function (PCF) 160, the Network Exposure Function (NEF) 170, the NF Repository Function (NRF) 180, and the Service Communication Proxy (SCP) 190.

Unified Data Management (UDM), such as UDM 150, refers to a particular NF or service related to the 5GC for managing user data/subscriber data. UDM acts as a front-end service for storing/retrieving subscription data for users in/from a UDR, e.g., UDR(s) 102. UDR can refer to a repository for subscription data, which can store the subscription data as customer profile information, customer authentication information, and encryption keys. That is, queries or requests can be made by some NF, such as a network data analytics function or a session management function, which may prompt the UDM to access the UDR to retrieve subscription data satisfying the query or request.

PCF 160 can manage and enforce policies related to quality of service (QoS), traffic management and resource allocation, and acts as a policy decision point in a 5G network. For example, PCF 160 can retrieve subscription information, including service entitlements, preferences, and QoS requirements from UDM 150. Such information serves as the basis for determining appropriate policy rules that are to be applied to a user's session/connection. The PCF may then communicate such policy rules to various control plane functions to ensure their enforcement.

NEF 170 may utilize UDM 150 to control user data exposure to external NFs. That is, NEF 170 may support the exposure of NF's capabilities in a 5G network to external NFs, such as third party application functions. External exposure can refer to monitoring capability, provisioning capability, policy/charging capability, and analytics reporting capability. For example, monitoring capability can refer to monitoring for a specific event for a UE in a 5G network, and making such monitoring events information available for external exposure via NEF 170.

NRF 180 can be used for service discovery of NFs. That is, NRF 180 can allow NFs to discover the service list offered by other NFs.

SCP 190 can function to forward messages and route messages to a destination NF or NF service, and to forward/route messages to a next hop SCP. Moreover, SCP 190 supports indirect communication whereby an NF service consumer may communicate with a target NF service producer via SCP 190. For example, the NF service consumer may perform discovery of the target NF service producer directly, or indirectly by delegating discovery of the target NF service producer to SCP 190. SCP 190 may use parameters provided by the NF service consumer to perform such discovery or selection of the target NF service producer.

In some scenarios, UDRs may act as NF producers while UDMs may act as NF consumers to UDRs. As noted above, a UDR may provide the Unified Directory Repository service to a UDM. For example, the UDM may wish to access/interact with the UDR (preferably in its locale) to retrieve, create, update, modify, or delete data stored in the UDR, such as user or subscription data. As will be discussed in greater detail below, UDR instances may register corresponding NF producer profiles with the NRF to allow a UDM to discover an appropriate UDR instance(s) that can satisfy a service request, such as a query to retrieve/return user or subscription data. However, storing/maintaining NF producer profiles can become onerous and difficult, especially with increased numbers of UDRs/UDR instances. Moreover, latencies associated with satisfying a service can increase due to the iterative process of discovering multiple NF producer profiles.

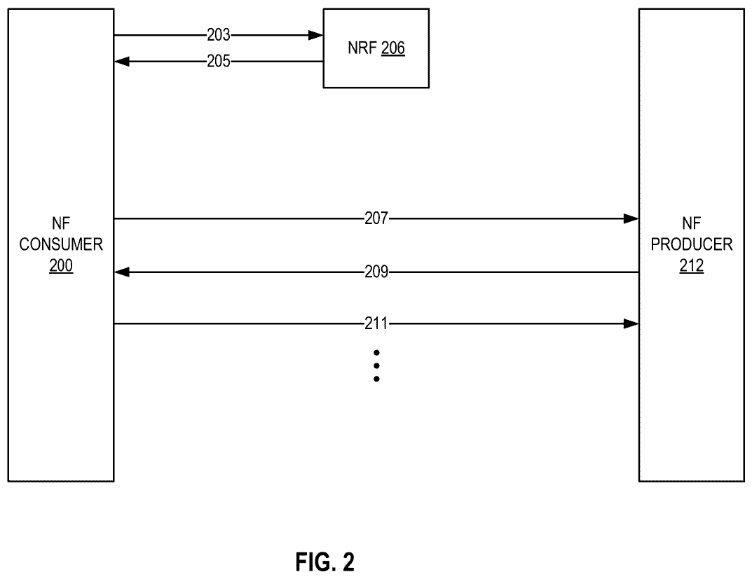

FIG. 2 illustrates interactions between an NF consumer, NF producer, and an NRF, in accordance with an example of the disclosed technology. Communications deployments typically expect to have a minimum of five 9's (99.999 percent) uptime of entities and their services. This makes certain functionalities, e.g., high-availability, geo-redundancy, and the like, unavoidable. For example, in order to achieve high-availability and geo-redundancy in the 5GC, multiple instances of a particular NF or service, or multiple entities of the same type may be registered with the NRF. In this way, the NF consumer may discover the NF producer/NF producer instances capable of satisfying a request from the NF consumer.

In the example of FIG. 2, NF consumer 200, which in some scenarios may be embodied as a UDM, performs service discovery to discover one or more NF producers, such as NF producer 212, which in some scenarios may be embodied as a UDR. To perform service discovery, NF consumer 200 may transmit a discovery request NRF 206. As noted above, the NRF is a central registry that can hold information about the NFs of the 5GC, which can then be shared with any NF, when required. That is, the NRF is itself, a 5GC NF that acts as a services discovery broker for NFs in the 5GC.

As also noted above, service discovery is the process of automatically finding what instance(s) of a service are able to fulfill a given request. In FIG. 2, NF consumer 200 may wish to satisfy some request. Accordingly, NF consumer 200 may send a discovery message 203 to NRF 206. Discovery message 203 may specify relevant parameters, such as the target (requesting) NF, in this case, NF consumer 200, parameters specifying service/request requirements, such as a desired locality of the NF producer, and so on. Upon receipt of discovery message 203, NRF 206 checks its associated database(s) for NF producers matching the requirements/parameters set forth in discovery request 203. NRF 206 selects one or more available NF producers from the NF producers registered at NRF 206 based on the parameter(s) specified by NF consumer 200 in discovery request 203. A list of available/capable NF producer instances 205 may be returned to NF consumer 200 by NRF 206. NF consumer 200 may select (or may delegate selection to a Service Communication Proxy (SCP) (not shown)) a desired one of the NF producer instances set forth in the list received by NF consumer 200. After sending a session request, e.g., packet data unit (PDU) session request, and undergoing authentication (not shown), NF consumer 200 may begin interacting with its chosen NF producer, in this case, NF producer 212.

That is, NF producer 212 registered itself with NRF 206, making itself discoverable to any other NF in the 5GC. Registration with NRF 206 involves registering an NF profile, where the NF profile comprises various attributes or parameters that characterize, e.g., an NF producer's capacity, priority, load, etc. Upon selecting NF producer 212, e.g., based on the locality of NF producer 212, and after establishing a communications session with NF producer 212, and undergoing an authentication/authorization procedure(s), NF consumer 200 may transmit service request 207 NF producer 212. NF producer 212 may provide a service response 209 back to the NF consumer, e.g., it may return certain data or a particular resource URL that can be used to satisfy the service request/provide the requested service. If NF consumer 200 has a subsequent request, it may transmit that subsequent request 211 to NF producer 212, and the process continues.

In conventional implementations, NFs, such as NF consumer 200, register themselves at the NRF, such as NRF 206, by uploading an NF profile, which again, contains information about the NF producer, the services it provides, the locality that it serves, and so on. Typically, in a given deployment, NFs are grouped together based on locality, and discover an appropriate NF producer indicating the locality it serves and some assigned, relative priority. As noted above, due, at least in part, to a communications service provider's expectation of five 9's uptime regarding a deployment's entities and services, NF producers register multiple profiles associated with different NF producer instances. For example, an NF producer may register multiple instances in an NRF, each profile corresponding to the each of the multiple NF producer instances. Each profile may specify a particular locality and priority. In this way, an NF producer can satisfy a service request from an NF consumer in another locality.

To the above, a problem with conventional implementations is fulfilling network routing requirements where multiple producers of the same NF type have registered (with an NRF) with same locality for failover. NF producers are spread across geographic localities for high availability, and assigning multiple NF producers to the same locality and with the same priority is not recommended, considering every geographic area will have its own locality, and the NF producer in that geographic area should be registered with that locality. A locality can refer to the site or position of, in this context, a network function/entity.

Moreover, the 3rd Generation Partnership Project (3GPP) does not allow for more than one locality value per profile. This too can contribute to an NF producer registering multiple NF profiles (per NF producer instances). That is, the 3GPP also defines a priority attribute for NF producers, which can be used to indicate if a given NF producer is a preferred NF producer. This priority attribute is also global (like the locality attribute). A consumer anywhere in the network tends to prefer a highest priority NF producer, and to define different priorities for different localities in a network, an NF producer registers multiple instances with different priorities/localities.

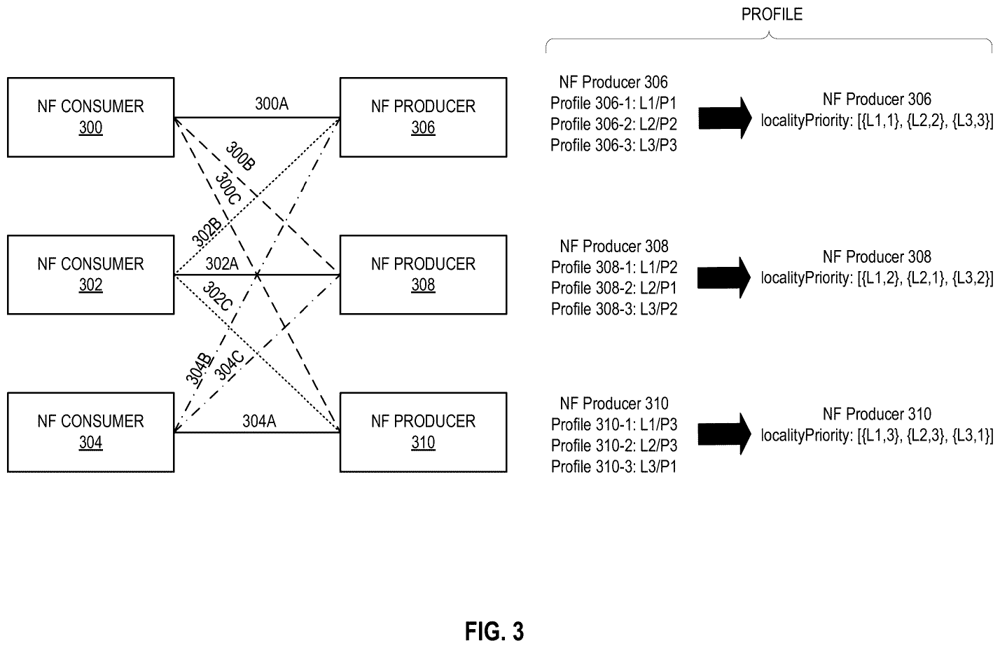

FIG. 3 illustrates a failover scenario in which examples of the disclosed technology may be used to avoid the aforementioned issues with conventional registration and discovery operations. FIG. 3 illustrates three NF consumers, NF consumers 300, 302, and 304. NF consumers 300-304 may wish to discover an NF producer that can satisfy a service request. For example, NF consumers 300-304 may each be UDMs seeking to modify subscriber records stored in an instance of one of NF producers 306, 308, or 310, each of which may be UDRs.

Typically, an NF consumer prefers a local or co-located (in the same locality) NF producer. In the example of FIG. 3, NF consumer 300 may be in the same locality (L1) as NF producer 306, NF consumer 302 may be in the same locality (L2) as NF producer 308, and NF consumer 304 may be in the same locality (L3) as NF producer 310. Accordingly, when performing service discovery, an NF consumer may tend to specify its locality as a discovery request parameter, or desired service characteristic. Specifying its locality indicates to the NRF (not shown in FIG. 3) that the NF consumer wishes to discover an NF producer in its (own) specified locality.

Typically, as noted above, an NF producer will register multiple profiles (corresponding to different instances) with the NRF. As illustrated in FIG. 3, NF producer 306 will register three profiles (to account for, in this scenario, the three localities supported by NF producer 306). A first profile 306-1 specifies a locality of L1, with a priority of P1. That means, when an NF consumer, such as NF consumer 300, transmits a discovery request (specifying a locality of L1, its own locality) to an NRF looking for a service/NF producer to satisfy its request, the NRF will search for any NF producer profiles that include L1 as a served locality. For example, NF consumer 300 may first be directed to NF producer 306 (300A). The priority value, P1, indicates that serving locality L1 is NF producer 306's first/top priority. In this way, NF producer 306 will be a preferred NF producer for NF consumer 300. For redundancy or failover purposes, NF producer 306 may also register other instances for serving other localities in accordance with other priorities. That is, NF producer 306 also registers profile 306-2 (specifying another instance of NF producer 306 capable of serving locality L2 in accordance with a priority P2), as well as profile 306-3 (specifying an NF producer 306 instance capable of serving locality L3 in accordance with a priority P). As can be appreciated from FIG. 3, NF producer 308 may also register multiple profiles with the NRF. In this example, NF producer 308 may register profile 308-1 (specifying the capability to serve locality L1 in accordance with a priority P2)), profile 308-2 (specifying the capability to serve locality L2 in accordance with its top priority P1), and profile 308-3 (specifying the capability to serve locality L3 in accordance with a priority P2). Similarly, NF producer 310 may register profile 310-1 (specifying the capability to serve locality L1 in accordance with its lowest priority P3)), profile 310-2 (specifying the capability to serve locality L2 in accordance with priority P3), and profile 310-3 (specifying the capability to serve locality L3 in accordance with its top priority P1).

In this way, if, e.g., NF producer 308, whose top priority is to serve locality L2 goes down, and NF consumer 302 cannot rely on NF producer 308 to service a request, NF consumer 302 can be directed instead, to NF producer 306, whose second priority is to serve locality L2, or to NF producer 310, whose third priority is to serve locality L3. In some scenarios, the various served localities and priorities associated with NF producers 306-310 can be used for load balancing purposes, e.g., to spread serving NF producers across some geographical area/multiple localities. In the event that NF consumer 304 wishes to discover an NF producer that can satisfy a service request in locality L3, NF consumer 304 may transmit a discovery request to an NRF, and NRF may return a list of NF producer profiles that can satisfy the service request. In this scenario, if NF producer 310 is down for some reason, and can't provide the requisite service(s) to NF consumer 304, the NRF may include in the list of NF producer profiles, profiles 308-3 and 306-3. Because profile 308-3 is associated with a priority of P2, NF consumer 304 may select to be serviced or receive service from NF producer 308.

That is, if, e.g., NF producer 306 fails, NF consumer 300 can be directed (300B) to NF producer 308 (based on profile 308-1 specifying a priority P2 for locality L1), and then directed (300C) to NF producer 310 (based on profile 310-1 specifying a priority P3 for locality L1). While NF consumer 302, in locality L2, may have a preference to be directed (302A) to NF producer 308 based on profile 308-2 (specifying a priority P1 for locality L2), if NF producer 308 goes down, NF consumer 302 can be directed (302B) to NF producer 306 (based on profile 308-1), and directed (302-C) to NF producer 310 (based on profile 310-2). Similarly, while NF consumer 304, in locality L3, may prefer to be directed (304A) to NF producer 310 based on profile 310-3 (specifying a top priority to serve locality L3, in the even NF producer 310 goes down, NF consumer 304 may be directed (304B) to NF producer 306 based on profile 310-1, or directed (304C) to NF producer 308 based on profile 310-2.

Although failover/load balancing can be achieved through the use of multiple profile registrations per NF producer, NF consumers may end up selecting any available NF producer which can impact 5G latency-sensitive services-hence, the inclusion of a priority in an NF producer profile. However, inclusion of a priority parameter increases the complexity of managing NF producers and their corresponding profiles. For example, if the number of NF consumers and NF producers is large, e.g., on the order of hundreds of NF consumers/producers, which can happen in a typical deployment, managing service discovery also increases. If some new entity, e.g., a new NF consumer or NF producer is introduced into the network/system, network routing/NF profiles will all be impacted, and all existing NF producer profiles would have to be reviewed/revised, and so on.

Although some networks may use routing proxies, such as Service Communication Proxies (SCPs), for indirect communication and topology hiding, NF producers must nevertheless, still register multiple profiles specifying locality, priority, etc. for service discovery purposes. Moreover, while NF producers may register multiple profiles, traffic with the NRF is increased. NF consumers may also be statically configured to define, e.g., primary, secondary, and tertiary NF producer targets/endpoints. However, static configurations at the NF consumer end also introduces unwanted traffic/processing overhead, and static configurations are difficult to scale because any changes to the network, priority, locality, etc. typically involves changing the static configurations. In other words, changes cannot be dynamically addressed.

Accordingly, a mechanism is introduced in accordance with examples of the disclosed technology to allow for “smart” registration, where a new, optional attribute can be introduced as part of an NF producer profile. NF producers can leverage this new, optional attribute, to register multiple localities and priorities to be supported in a single NF profile. In this way, multiple NF producer instances can still be registered to support NF consumers without introducing complexity in network processing or management. Moreover, an NRF may consider such smartly-registered profiles to satisfy discovery requests, and the searches performed by the NRF for NF producer instances/profiles can be optimized. NRF queries, for example, can be performed much faster inasmuch as only a single NF profile is retrieved, where the single NF profile, nevertheless, provides the same, requisite NF producer characteristics information. From an NF consumer standpoint, a preferred or “best” end point/NF producer for routing can be selected based on smart profiles returned by the NRF.

According to 3GPP Specification #29.510, section 6.1.6.2.2, the structured data type NFProfile is defined. As defined, the NFProfile data type can comprise a variety of different attributes and associated information, such as “Nf InstanceId,” “nfType,” “nfStatus,” and so on. In accordance with examples of the disclosed technology, a new optional parameter, which can be referred to as “localityPriority,” can be introduced into NF profiles for NF producers. It should be noted that in various scenarios, an NF consumer can be an NF producer for another NF consumer. That is, most any NF can act as either an NF consumer or NF producer, depending on the scenario at issue. The localityPriority parameter can be defined as follows in Table 1.

TABLE 1

| Attribute | Data type | P | Cardinality | Description |
|---|---|---|---|---|
| localityPriority | array | O | 0 . . . 1 | This parameter shall be used when there is |
| | (locality, | | | a requirement for multiple localities to be |
| | priority) | | | supported by a NF. |
| | | | | localityPriority (locality1, 1; locality2, 2; . . . |
| | | | | localityn, m) |
| | | | | Producers: will get registered for multiple |
| | | | | localities with different priorities under |
| | | | | single profile. |
| | | | | Consumers: once discover producers |
| | | | | based on locality, will get localityPriority to |
| | | | | decide where to route the request. |

As set forth above in Table 1, the new optional parameter/attribute is named “localityPriority,” and is an array data type, the array including locality and priority values. The presence condition “P” is optional “O,” meaning inclusion of this parameter/attribute is optional, and not, e.g., mandatory. The cardinality of the localityPriority parameter is specified as being 0 . . . 1, meaning there is a possibility of the localityPriority parameter being associated with up to two unique data values, that of the locality and that of the priority. The description of the localityPriority parameter indicates when the parameter is to be used, i.e., when there is a requirement that an NF producer support multiple localities. The description sets forth the syntax of the localityPriority parameter, while also describing associated NF consumer and NF producer operations using/in light of the localityPriority parameter. That is, NF producers can register multiple localities and corresponding priorities under a single profile, and NF consumers, once NF producers are discovered based on locality, can decide which NF producer to which a service request can be routed.

Referring back to FIG. 3, use of the localityPriority parameter or attribute is illustrated. Instead of NF producers 306, 308, and 310 each registering three different NF profiles associated with respective instances of NF producers 306, 308, and 310, NF producers 306, 308, and 310 need only register a single NF profile. Because each of NF producers 306, 308, and 310 are intended to or are capable of serving multiple localities, per varying priorities, each of NF producers 306, 308, and 310 leverages the localityPriority parameter when registering with an NRF. For example, the profile for NF producer 306 may be “localPriority: [{L1,1}, {L2,2}, {L3,3}],” the profile for NF producer 308 may be localPriority: [{L1,2}, {L2,1}, {L3,3}],” and the profile for NF producer 310 may be localPriority: [{L1,3}, {L2,2}, {L3,1}].” This localityPriority parameter is able to capture the information or data of what was previously set forth in a plurality of profiles corresponding to different instances of an NF producer.

As with the prior discussion of FIG. 3, NF consumers 300-304 (in localities L1, L2, and L3, respectively) may seek the services of an NF producer in its locale (preferably, NF consumer 300 is directed to NF producer 306, NF consumer 302 is directed to NF producer 308, and NF consumer 304 is directed to NF producer 310, based on primary or top priorities associated with the localities served by the NF producers 306-310). In the case of NF consumer 300, if NF producer 306 goes down, NF consumer 300 would still be provided with a list of capable/available NF producers, e.g., NF producers 308 and 310 based on the NRF identifying capabilities via NF producer 308 and 310's localityPriority parameter. However, the need to manage multiple profiles is avoided by using a single profile, as is the 3GPP constraint that only a single locality is to be associated with any single NF profile. One or more of producers 306-310 can serve one or more of NF consumers 300-304 in the same way, according to the same preferences/priority as would be accomplished with the use of multiple profiles per NF producer, but with only a single profile per NF producer instead. An NF consumer is able to glean the same information from a single, smart NF profile as from multiple, conventional NF profiles. By analyzing or parsing the localityPriority parameter, NF consumer 300 can be directed first, to NF producer 306 based on the localityPriority parameter specifying a locality and priority of {L1,1}. If NF producer 306 is unavailable, NF consumer 300 can be directed next to NF producer 308 in accordance with the localityPriority parameter of NF producer 308 specifying a locality/priority of {L1,2}, or to NF producer 310 in accordance with the localityPriority parameter of NF producer 310 specifying a locality/priority of {L1,3}. Likewise, if NF producer 308 fails, NF consumer 302 may, instead of being directed to NF producer 306 in accordance with its registered profiles specifying a locality/priority of {L2,1}, be directed to NF producer 306 with a registered profile specifying a locality/priority of {L2,2} or to NF producer 310 with a registered profile specifying locality/priority of {L2,3}. If NF producer 310 fails, NF consumer 304 may, instead of being directed to NF producer 310 pursuant to the NF producer 310's registered profile specifying a locality/priority of {L3,1}, be directed to NF producer 308 with a registered profile specifying locality/priority of {L3,2} or to NF producer 306 with a registered profile specifying locality/priority of {L3,3}.

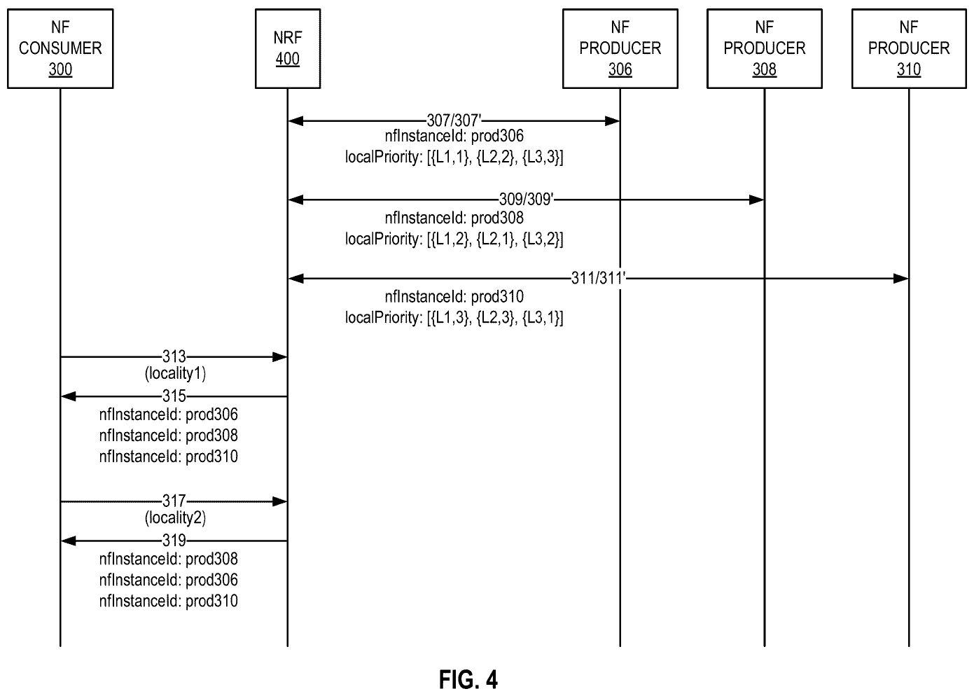

FIG. 4 illustrates example messages and operations that may be performed amongst an NF consumer, an NRF, and a plurality of NF producers to satisfy a requested service using a single, smart NF producer profile registered with the NRF. As described above, NF producers, which can be most any type of NF, register with an NRF to allow themselves to be discoverable by other NFs seeking satisfaction or resolution of a service/request. Here, NF producers 306, 308, and 310 may register with NRF 400. For example, NF producer 306 may register itself with NRF 400 by sending a registration message indicating itself as the registering entity, and specifying certain attributes, including the specification of the localityPriority parameter. That is, NF producer 306 may send a PUT request 307 to NRF 400 with a resource Uniform Resource Identifier (URI) representing the NF instance, in this example NF producer 306. This PUT request is transmitted along with a variable, nfInstanceId, representing an identifier (e.g., a Universally Unique Identifier (UUID)) provided by NF producer 306 that is globally unique inside the Public Land Mobile network (PLMN) of NRF 400 to which NF producer 306 is being registered. In this example, the nfInstanceId may be “prod306.” The PUT request is also transmitted with a representation of the NF instance, i.e., NF producer 306, in the form of an NF profile. The relevant portion of an NF profile, in the context of the disclosed technology, is the localityPriority parameter. That is, a registration request/PUT message may comprise other information/parameters/attributes, but for purposes of the disclosed technology, only the localityPriority parameter will be discussed.

In the case of NF producer 306, that localityPriority parameter is [{L1,1}, {L2,2}, {L3,3}]. In this way, NF producer 306 has specified additional resource configurations to consider multiple localities associated with a single nfInstance/NF producer, and can register a single profile. NRF 400 may then transmit, if registration is successful, a response indicating the profile was created, along with the profile as the payload. For example, NRF 400 may return to NF producer 306, a “201 Created” status code message 307′ indicating successful creation of an NF profile for NF producer 306, along with a copy of the NF profile, which in this example, includes the localityPriority parameter, as well as, e.g., a heartbeat timer” identifying the number of seconds expected between two consecutive heartbeat messages from NF producer 306 to NRF 400. If registration fails, NRF 400 can return, e.g., a “500 Internal Server Error” status code message or “400 Bad Request” status code message depending on the reason for the failed registration.

Similarly, in the case of NF producer 308, NF producer 308 may transmit a PUT request 309 to NRF 400 identifying itself with a nfInstanceId of “prod308,” and its smart profile, which includes a localityPriority parameter of [{L1,2}, {L2,1}, {L3,2}]. If registration is successful, NRF 400 may send a successful status code message 309′ back to NF producer 308 along with a payload, i.e., the profile for NF producer 308. If unsuccessful, the response message 309′ may comprise one of the aforementioned “500 Internal Server Error” or “400 Bad Request” status code messages. NF producer 310 may also transmit a PUT request 311 to NRF 400 identifying itself with a nfInstanceId of “prod310,” and its smart profile, which includes a localityPriority parameter of [{L1,3}, {L2,3}, {L3,1}]. If registration is successful, NRF 400 may send a successful status code message 311′ back to NF producer 308 along with a payload, i.e., the profile for NF producer 308. If unsuccessful, the response message 311′ may comprise one of the aforementioned “500 Internal Server Error” or “400 Bad Request” status code messages.

When an NF consumer, such as NF consumer 300 wishes to perform discovery to discover available NF producers that are capable of providing the requested service(s) to NF consumer 300, NF consumer 300 can transmit a discovery request 313 to NRF 400. As discussed above, an NRF, such as NRF 400, may be a centralized NF repository that can act as a service broker in the 5GC. Once NF producers 306-310 are registered with NRF 400, NRF 400 can provide them/direct an NF consumer to them if they are available and can satisfy a request.

In FIG. 4, NF consumer 300 transmits a discovery request message 313 to NRF 400. The discovery message 313, in this example, specifies “locality1” as the locality for which NF consumer 300 wants an NF producer to provide the requested service. As noted above, the localityPriority parameter is optional parameter to include in an NF profile. In this case, each of NF producers 306-310 included the localityPriority parameter in their respective registered profiles. Accordingly, NRF 400 checks the localityPriority values for the requested locality, in this example, locality1, amongst its registered profiles. If NRF 400 identifies any match(es) between the locality specified in NF consumer 300's discovery request and any of the registered profiles, NRF 400 can return a list of identifiers associated with the NF producers whose localityPriority parameter specifies the ability to provide a service to locality1. In this example, NF producers 306, 308, and 310 can all potentially service locality1. Thus, NRF 400 returns profiles corresponding to NF producers 306-10 that are identified (in priority order) as follows: nfInstanceId: prod306; nfInstanceId: prod308; nfInstanceId: prod310.

In the event that the localityPriority parameter is not present in a profile (meaning the particular NF associated with the profile does not support multiple localities under a single NF instance), NRF 400 can perform a search for locality1 in a conventional locality parameter of a profile, along with a conventional priority parameter of the profile. It should be noted that if NRF 400 does not return the profiles of relevant NF producers in a priority order, the NF consumer 300 can look for the localityPriority parameter in the returned profiles. NF consumer 300 can then select an NF producer whose localityPriority parameter specifies a matching locality value, e.g., locality1, with the highest specified priority.

As another example, NF consumer 300 may transmit a discovery request message 317 to NRF 400. The discovery message 317 in this case, specifies “locality2” as the locality for which NF consumer 300 wants an NF producer to provide the requested service. In this case, each of NF producers 306-310 included the localityPriority parameter in their respective registered profiles, and NRF 400 can check the localityPriority values for the requested locality, in this example, locality2. If NRF 400 identifies any match(es) between the locality specified in NF consumer 300's discovery request and any of the registered profiles, NRF 400 can return a list of identifiers associated with the NF producers whose localityPriority parameter specifies the ability to provide a service to locality2. In this example, NF producers 306, 308, and 310 can all potentially service locality2. Thus, NRF 400 returns profiles corresponding to NF producers 306-10 that are identified (in priority order) as follows: nfInstanceId: prod308; nfInstanceId: prod306; nfInstanceId: prod310.

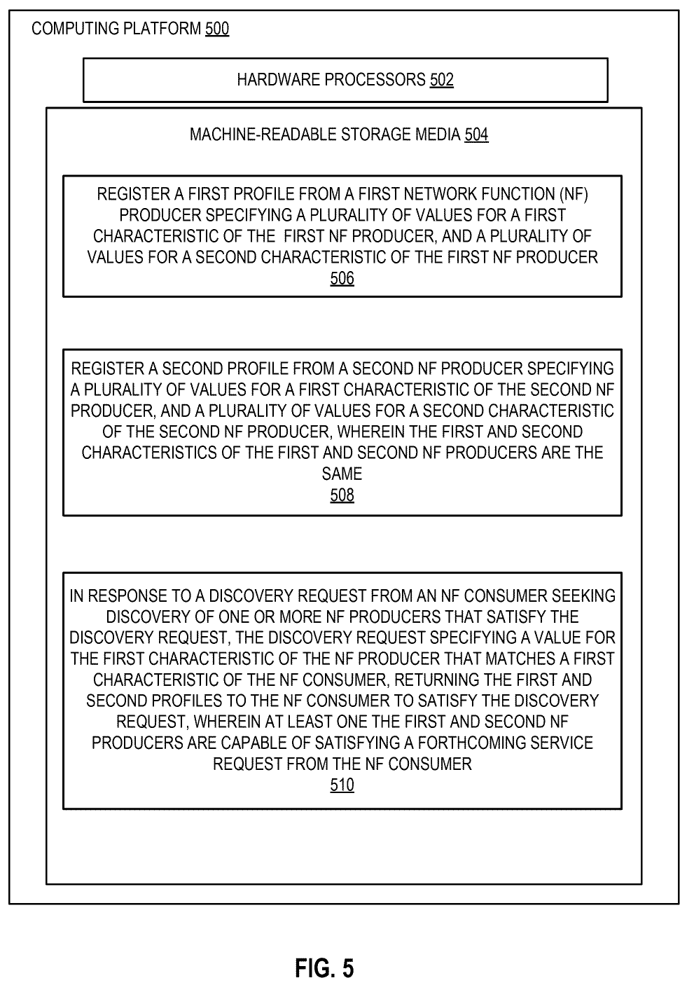

FIG. 5 illustrates a computing component that may be used to execute instructions to achieve smart NF registration and NF discovery in accordance with examples of the disclosed technology. Referring now to FIG. 5, computing component 500 may be, for example, a server computer, a controller, or any other similar computing component capable of processing data, e.g., a server/processor associated with the NRF of a 5GC network. In the example implementation of FIG. 5, computing component 500 includes a hardware processor 502, and machine-readable storage media 504.

Hardware processor 502 may be one or more central processing units (CPUs), semiconductor-based microprocessors, and/or other hardware devices suitable for retrieval and execution of instructions stored in machine-readable storage media 404. Hardware processor 502 may fetch, decode, and execute instructions, such as instructions 506-510. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 504, may be any electronic, magnetic, optical, or other physical storage device that contains or stores executable instructions. Thus, machine-readable storage media 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 404 may be a non-transitory storage medium, where the term “non-transitory” does not encompass transitory propagating signals. As described in detail below, machine-readable storage media 504 may be encoded with executable instructions, for example, instructions 506-510.

Hardware processor 502 may execute instruction 506 to register a first profile from a first NF producer specifying a plurality of values for a first characteristic of the first NF producer, and a plurality of values for a second characteristic of the first NF producer. As discussed above, NF producers may register with an NRF so that the NF producers may be discoverable by other NFs, such as NF consumers requesting a service or requesting satisfaction of some service. In accordance with examples of the disclosed technology, NFs, such as NF producers, can register themselves with an NRF using a single profile that can specify various values for particular characteristics of the NF producers. For example, the first characteristic may be locality, while the second characteristic may be priority. An NF producer can specify values for locality along with different corresponding priorities in an array, such as that described regarding the localityPriority parameter.

Hardware processor 502 may execute instruction 508 to register a second profile from a second NF producer specifying a plurality of values for a first characteristic of the second NF producer, and a plurality of values for a second characteristic of the second NF producer, wherein the first and second characteristics of the first and second NF producers are the same. Following the above examples, again, NF producers may register a single profile and specify multiple characteristics including locality and priority using the optional localityPriority parameter described herein. Specifying multiple localities and priorities allows an NF consumer to be serviced by various NF producers should, e.g., a preferred NF producer fails or does down, and the NF consumer is to be directed to another NF producer.

Hardware processor 502 may execute instruction 510 to, in response to a discovery request from an NF consumer seeking discovery of one or more NF producers that satisfy the discovery request, the discovery request specifying a value for the first characteristics of the NF producer that matches a first characteristic of the NF consumer, returning the first and second profiles to the NF consumer to satisfy the discovery request, wherein at least one of the first and second NF producers are capable of satisfying a forthcoming service request from the NF consumer. As described above, an NRF may receive a discovery request from an NF consumer specifying a particular locality. The NRF may search its registered profiles by looking for a matching locality specified in a localityPriority parameter of the registered profiles, if such a parameter exists (recalling the localityPriority parameter is optional). If a match exists, the NRF can return a list of those registered profiles whose localityPriority parameter specifies a locality that matches the locality specified by the NF consumer in the discovery request. Upon selecting an available and capable NF producer, the NF consumer may send a service request to that selected NF producer.

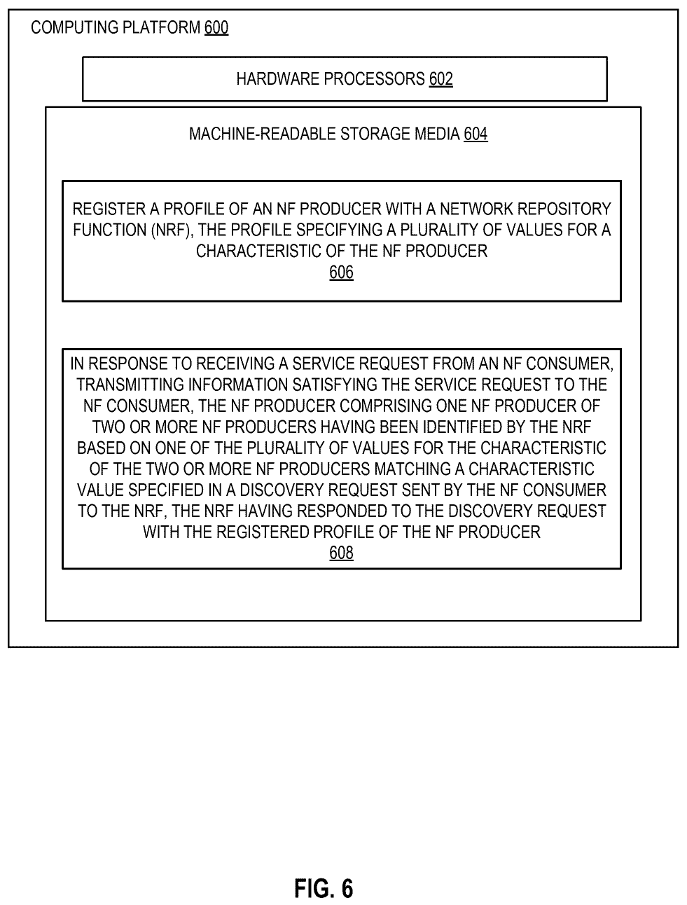

FIG. 6 illustrates a computing component that may be used to execute instructions to achieve service satisfaction by an NF, such as an NF producer entity using smart registration and service discovery in accordance with examples of the disclosed technology. Referring now to FIG. 6, computing component 600 may be, for example, a server computer, a controller, or any other similar computing component capable of processing data. In the example implementation of FIG. 6, computing component 600 includes a hardware processor 602, and machine-readable storage media 604.

Hardware processor 602 may be one or more central processing units (CPUs), semiconductor-based microprocessors, and/or other hardware devices suitable for retrieval and execution of instructions stored in machine-readable storage media 604. Hardware processor 602 may fetch, decode, and execute instructions, such as instructions 606-608. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 604, may be any electronic, magnetic, optical, or other physical storage device that contains or stores executable instructions. Thus, machine-readable storage media 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 604 may be a non-transitory storage medium, where the term “non-transitory” does not encompass transitory propagating signals. As described in detail below, machine-readable storage media 604 may be encoded with executable instructions, for example, instructions 606-608.

Hardware processor 602 may execute instruction 606 to register a profile of an NF producer with an NRF, the profile specifying a plurality of values for a characteristic of the NF producer. As described above, in order to be discoverable, NF producers register themselves, via NF profiles, with an NRF. In accordance with examples of the disclosed technology, such an NF profile may be a smart profile or smart-registered profile in that, unlike conventional profiles, where one profile is limited to one value for one characteristic, e.g., locality, a smart profile can specify multiple values for a given characteristic. That is, if a particular NF producer can support services in multiple localities, it may register a single profile in which those multiple localities are specified using a localityPriority parameter.

Hardware processor 602 may execute instruction 608 to, in response to receiving a service request from an NF consumer, transmitting information satisfying the service request to the NF consumer, the NF producer comprising one NF producer of two or more NF producers having been identified by the NRF based one of the plurality of values for the characteristic of the two or more NF producers matching a characteristic value specified in a discovery request sent by the NF consumer to the NRF, the NRF having responded to the discovery request with the registered profile of the two or more NF producer. As described above, the NRF may search profiles NF producers have registered with the NRF by looking for a matching locality specified in a localityPriority parameter of the registered profiles. If a match exists, the NRF can return a list of those registered profiles whose localityPriority parameter specifies a locality that matches the locality specified by the NF consumer in the discovery request. Upon selecting an available and capable NF producer, the NF consumer may send a service request to the selected NF producer. The selected NF producer may respond with the requisite information to provide the requested service/satisfy the requested service.

As noted above, examples of the disclosed technology are able to overcome the 3GPP specification limiting support by a single NF instance (reflected by a single NF profile) to a single locality and priority. Deployment topology is simplified in scenarios where NFs at one site are to act as a backup or secondary choice for another site based on localities. The management of NF profiles, where each NF supports multiple localities becomes simpler via use of the localityPriority parameter in NF profiles. With a reduction in the number of registered profiles at the NRF, the processing/compute load associated with managing NF profiles on the NRF, and messaging heartbeats, etc. can be drastically reduced.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.]

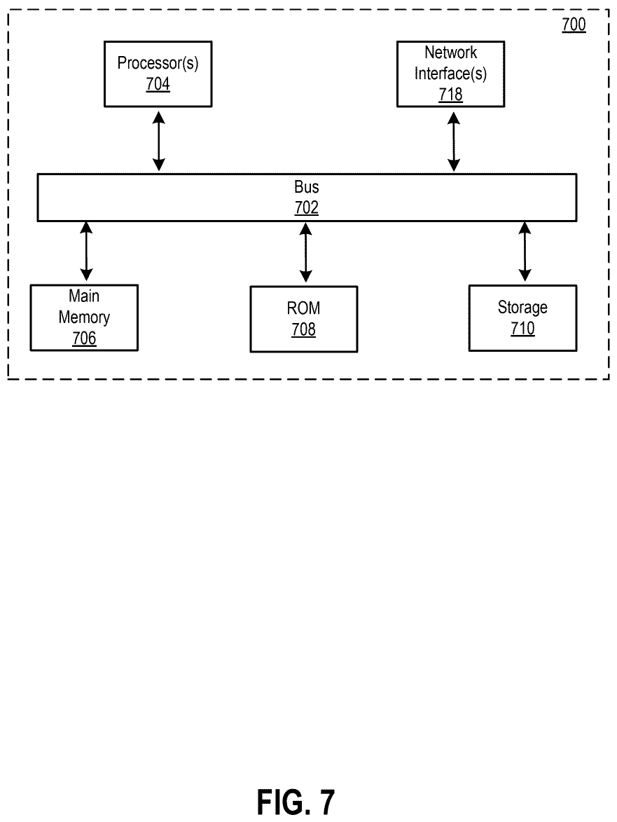

FIG. 7 depicts a block diagram of an example computer system 700 in which various examples of the disclosed technology described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same. Non-transitory media is distinct from but may be used in conjunction with transmission media.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicate with a WAN). Wireless links may also be implemented. In any such implementation, network interface 718 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a processor; and
a memory including instructions that when executed, cause the processor to:
register a first profile from a first network function (NF) producer specifying a plurality of values for a first characteristic of the first NF producer, and a plurality of values for a second characteristic of the first NF producer;
register a second profile from a second NF producer specifying a plurality of values for the first characteristic of the second NF producer, and a plurality of values for the second characteristic of the second NF producer, wherein the first and second characteristics of the first and second NF producers are the same;
in response to a discovery request from an NF consumer seeking discovery of one or more NF producers that satisfy the discovery request, the discovery request specifying a value for the first characteristic of the NF producer that matches a first characteristic of the NF consumer, returning the first and second profiles to the NF consumer to satisfy the discovery request, wherein at least one the first and second NF producers are capable of satisfying a forthcoming service request from the NF consumer.

2. The system of claim 1 comprising a Network Repository Function (NRF), wherein the first NF producer comprises a first User Data Repository (UDR), wherein the second NF producer comprises a second UDR, and further wherein the NF consumer comprises a.

3. The system of claim 1, wherein the first characteristic comprises a locality parameter, and wherein the second characteristic comprises a priority parameter.

4. The system of claim 3, wherein the plurality of values for the locality parameter comprise locality identifiers associated with one or more localities of the first NF producer and the second NF producer relative to a locality of the NF consumer.

5. The system of claim 4, wherein the plurality of values for the priority parameter comprise priority identifiers reflecting priorities associated with satisfying the forthcoming service request from the NF consumer based on the locality of the NF consumer.

6. The system of claim 5, wherein the first and second profiles comprise arrays of the locality identifiers and corresponding priority identifiers.

7. The system of claim 6, wherein the arrays of the locality identifiers and corresponding priority identifiers specify prioritized failover options for the satisfaction of the forthcoming service request.

8. A method, comprising:
registering, at first network function (NF), a first profile from a second NF specifying a plurality of values for a first characteristic of the second NF, and a plurality of values for a second characteristic of the second NF;
register a second profile from a third NF specifying a plurality of values for the first characteristic of the third NF, and a plurality of values for the second characteristic of the third NF, wherein the first and second characteristics of the second and third NFs are the same;
in response to a discovery request from a fourth NF seeking discovery of one or more NFs that satisfy the discovery request, the discovery request specifying a value for the first characteristic of the second NF that matches a first characteristic of the fourth NF consumer, returning the first and second profiles to the fourth NF to satisfy the discovery request, wherein at least one the second and third NFs are capable of satisfying a forthcoming service request from the fourth NF.

9. The method of claim 8, wherein the first NF comprises a Network Repository Function (NRF), the second and third NFs comprise NF producers, and the fourth NF comprises an NF consumer.

10. The method of claim 8, wherein the first characteristic comprises a locality parameter, and wherein the second characteristic comprises a priority parameter.

11. The method of claim 10, wherein the plurality of values for the locality parameter comprise locality identifiers associated with one or more localities of the second NF and the third NF relative to a locality of the fourth NF.

12. The method of claim 11, wherein the plurality of values for the priority parameter comprise priority identifiers reflecting priorities associated with satisfying the forthcoming service request from the fourth NF based on the locality of the fourth consumer.

13. The method of claim 12, wherein the first and second profiles comprise arrays of the locality identifiers and corresponding priority identifiers.

14. The method of claim 13, wherein the arrays of the locality identifiers and corresponding priority identifiers specify prioritized failover options of prioritized load balancing options for the satisfaction of the forthcoming service request.

15. A network function (NF) producer, comprising:
a processor; and
a memory including instructions that when executed, cause the processor to:
register a profile of the NF producer with a network repository function (NRF), the profile specifying a plurality of values for a characteristic of the NF producer; and
in response to receiving a service request from an NF consumer, transmitting information satisfying the service request to the NF consumer, the NF producer comprising one NF producer of two or more NF producers having been identified by the NRF based on one of the plurality of values for the characteristic of the two or more NF producers matching a characteristic value specified in a discovery request sent by the NF consumer to the NRF, the NRF having responded to the discovery request with the registered profile of the NF producer.

16. The NF producer of claim 15, wherein the response to the discovery request further includes the registered profiles of the other(s) of the two or more NF producers.

17. The NF producer of claim 15, wherein the characteristic comprises a locality-priority parameter array specifying a plurality of locality identifiers and associated priority identifiers.

18. The NF producer of claim 17, wherein the NF producer receives the service request from the NF consumer in response to the NF consumer selecting the NF producer from the plurality of registered profiles received from the NRF considering NF consumer locality preferences regarding the satisfaction of the service request.

19. The NF producer of claim 17, wherein the locality-priority parameter array specifies failover or load balancing options for the satisfaction of the service request.

20. The NF producer of claim 15, wherein the NF producer comprises a User Data Repository (UDR) NF, and wherein the NF consumer comprises a Unified Data Management (UDM) NF.
